(19) United States
(12) Patent Application Publication
(10) Pub. No.: US 2024/0219219 A1
(43) Pub. Date: Jul. 4, 2024

(54) ESTIMATING POOL VOLUME SYSTEM AND METHOD

(71) Applicant: Pentair Water Pool and Spa, Inc., Cary, NC (US)

(72) Inventors: Azur Dzindo, Woodland Hills, CA (US); Mitchell Bellamy, Sanford, NC (US); Sean McEwan, Chapel Hill, NC (US); Gerard Callahan, Smithfield, NC (US); Keith Lewis, New Hill, NC (US)

(21) Appl. No.: 18/397,839

(22) Filed: Dec. 27, 2023

Related U.S. Application Data
(60) Provisional application No. 63/477,794, filed on Dec. 29, 2022.

(51) Int. Cl. G01F 22/02; E04H 4/12; E04H 4/14

(52) U.S. Cl. CPC G01F 22/02; E04H 4/1281; E04H 4/129; E04H 4/14

(57) ABSTRACT

Various systems and methods for determining pool volume are provided. A method for calibrating a pool device for a swimming pool or spa comprises injecting a known quantity of a chemical tracer reagent into the pool water, circulating the pool water of the pool or spa system for a pre-determined period of time, and measuring the concentration of the chemical tracer reagent via a sensor. The method further includes the steps of calculating the volume of the pool or spa system based on the measured concentration, inputting the volume into a user interface in communication with a pool device, and automatically adjusting at least one operating parameter of the swimming pool or spa based on the volume.

### RELATED APPLICATIONS

This application claims priority to U.S. Provisional Patent Application No. 63/477,794, filed Dec. 29, 2022, the entire disclosure of which is incorporated herein by reference.

### TECHNICAL FIELD

The present disclosure generally relates to estimating swimming pool volume. More particularly, this disclosure relates to estimating the volume of a pool system using various systems, such as sensors, and methods, and calibrating at least one swimming pool device based on the estimated volume.

### BACKGROUND

Pool pad systems used in conjunction with an aquatic application are an important aspect of maintaining water quality and ensuring healthy conditions in swimming pools, hot tubs, plunge pools, and other recreational water venues. Conventional pool pad systems can include various components such as pumps, filters, heaters, water quality monitoring systems, chemical management systems, valves, and other similar components for monitoring and controlling water quality. Moreover, the pool itself may include additional components for monitoring and controlling water quality, including, but not limited to, pool cleaners, drains, and skimmers. Some traditional pool systems can operate, adjust, and modify operational parameters of one or more of the components such as filter run time, pump speed, chemical dosage rate, heater run time, maintenance schedules, and the like based on pool volume. Thus, a user may input the pool volume into a user interface of a controller designed to monitor and control one or more pool devices. However, it can be difficult for a user to know the correct volume to input because the original design information may not be accessible, and the volume information was not measured at the time the pool was built. Additionally, the pool may be a custom size, the pool may be a unique shape not easily measured, and other similar issues could make it difficult to determine accurate pool volume. Thus, the user may enter an incorrect volume or may not enter a value at all impacting the components of the pool pad system and/or effect the water quality of the pool.

Therefore, it would be beneficial for a system and method for determining the volume of a pool and adjusting or calibrating one or more operating parameters of one or more of the pool components based on the determined volume to help ensure that the system components are operating at full efficiency and that desirable water quality is maintained.

### SUMMARY

In one instance, a method for calibrating a pool device for a swimming pool or spa is provided. The method comprises the steps of measuring a first water temperature of pool water via a sensor at a first calibration time, operating a heater to heat the pool water, measuring a second water temperature of pool water via the sensor at a second calibration time, and determining a run time of the heater with a controller based on a difference between the second calibration time and the first calibration time. The method further includes the steps of determining a temperature change in the water temperature with the controller based on a difference in temperature of the pool water between the second calibration time and the first calibration time, determining a volume of the pool based on at least one of the run time of the heater, the change in the water temperature, or a heating rate of the heater, and adjusting at least one operating parameter of the pool device based on the volume of the pool.

In one instance, a method for calibrating a pool device for a swimming pool or spa includes the steps of measuring water pressure of pool water at a first location via a submersible vehicle comprising a pressure sensor, measuring water pressure of pool water at a second location via the submersible vehicle, and inputting the water pressure into a user interface in communication with a pool device. The pool device determines the depth of the swimming pool at each location based on the measured pressure, tracks the location of the submersible vehicle, determines a shape of the swimming pool or spa based on the tracked locations, and calculates the volume of the swimming pool or spa based on the shape and the depth of the swimming pool or spa. The volume is input into a user interface in communication with a pool device, and at least one operating parameter of the swimming pool or spa is automatically adjusted based on the volume.

In yet another instance, a method for calibrating a pool device for a swimming pool or spa includes injecting a known quantity of a chemical tracer reagent into the pool water, circulating the pool water of the pool or spa system for a pre-determined period of time, and measuring the concentration of the chemical tracer reagent via a sensor. The method further includes calculating the volume of the pool or spa system based on the measured concentration of the chemical tracer reagent, inputting the volume into a user interface for the pool device wherein the user interface is in communication with a pool device, and automatically adjusting at least one operating parameter of the pool device based on the volume of the pool.

In some instances, the concentration of the chemical tracer reagent is measured with a colorimeter. In some instances, the chemical tracer reagent is cyanuric acid, and a baseline concentration of the cyanuric acid is measured prior to the chemical tracer reagent being injected into the pool or spa system.

In some instances, the sensor is associated with or otherwise integrated into one or more of an automated pool cleaner, a light located inside the pool, a light located outside the pool, a floating chemical dispenser, a skimmer, a filter, a chemical management system, an aerial device, or combinations thereof.

In some instances, the user interface is provided in the form of a local controller, a remote controller, and combinations thereof.

In some instances, the controller includes a receiver designed to receive information from the sensor relating to the volume of the pool or spa system, a processor configured to analyze the received information, and a transmitter configured to transmit instructions to one or more pool devices to control an operating parameter of the one or more pool devices.

In one instance, a method for calibrating a pool device for a pool is provided. The method includes providing a sensor, collecting pool data with the sensor, determining a volume of the pool based on the collected pool data, inputting the determined volume of the pool into a user interface, and adjusting at least one operating parameter of the pool device based on the determined volume of the pool.

In one instance, a system for calibrating a pool device for a pool is provided. The system includes a sensor designed to collect pool data, a controller in communication with the sensor, and a user interface in communication with the controller. The controller is designed to collect pool data from the sensor and determine a volume of the pool based on the collected pool data. The determined volume of the pool may be entered into the user interface, and the controller is further designed to adjust at least one operating parameter of the pool device based on the determined volume of the pool.

In yet another instance, a system designed to calibrate a pool device for a pool is provided. The system includes a heater designed to heat pool water, and a sensor designed to measure a first water temperature of the pool water at a first calibration time. The sensor is further designed to measure a second water temperature of the pool water at a second calibration time. The system also includes a controller designed to determine a run time of the heater based on a difference between the first calibration time and the second calibration time, determine a change in the water temperature based on a difference in temperature of the pool water between the first calibration time and the second calibration time, determine a volume of the pool based on at least one of the run time of the heater, the change in the water temperature, or a heating rate of the heater, store the volume of the pool into a user interface for the pool device, and adjust at least one operating parameter of the pool device based on the volume of the pool.

In another instance, a system designed to calibrate a pool device for a pool is provided. The system includes a sensor designed to collect pool data, a controller in communication with the sensor, and a chemical dispenser designed to dispense a chemical tracer reagent into water of the pool. The controller is designed to circulate the water of the pool for a pre-determined period of time, measure a concentration of the chemical tracer reagent, calculate a volume of the pool based on the measured concentration of the chemical tracer reagent, input the volume of the pool into a user interface for the pool device, and automatically adjust at least one operating parameter of the pool device based on the volume of the pool.

### DESCRIPTION OF THE DRAWINGS

FIG. 1 is a schematic block diagram depicting a conventional swimming pool and a pool pad with one or more components;

FIG. 2 is a schematic diagram illustrating a method of measuring pool volume according to one embodiment;

FIG. 3 is a schematic diagram illustrating a method of measuring pool volume according to another embodiment;

FIG. 4 is a schematic diagram illustrating a method of measuring pool volume according to yet another embodiment; and

FIG. 5 is a schematic block diagram illustrating a method of measuring pool volume according to a further embodiment.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

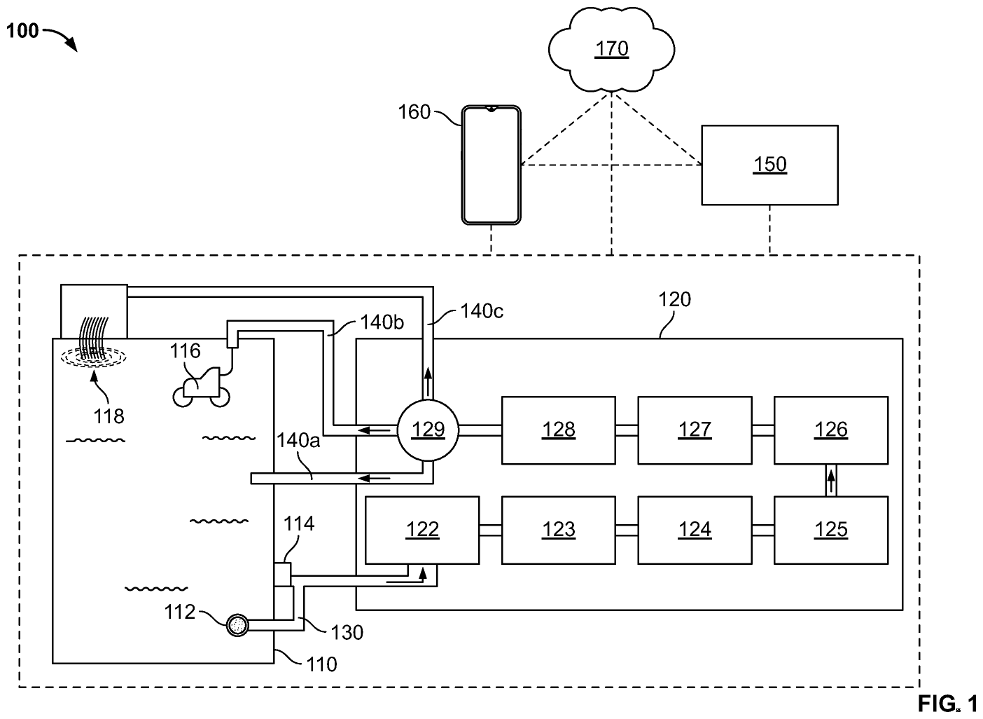

FIG. 1 illustrates an exemplary aquatic application, such as a pool or spa system 100, according to disclosed embodiments. As seen in FIG. 1, the pool or spa system 100 can include a pool or spa 110 in fluid communication with a pool pad 120. The pool 110 may include various components, such as a drain 112, a skimmer 114, a pool cleaner 116, and a water feature 118 in fluid communication with the pool pad 120. The pool pad 120 can include at least one of the following components (e.g., devices), including, for example, a variable speed pump 122, a booster pump 123, a filter 124, a heating system 125, a sanitizer 126, a water quality monitor 127, a pH regulator 128, and at least one valve 129. Thus, the pool 110 and the pool pad 120 form a fluid circuit. For example, water from the pool 110 may enter the pool pad 120 through an inlet line 130 and may be returned to the pool 110 through a first return line 140a, a second return line 140b, and/or a third return line 140c. The fluid circuit facilitates various tasks, including, for example, pumping, cleaning, heating, sanitizing, and the like.

At least one sensor or probe (not shown) can be included in the system 100 to monitor the water quality and/or water chemistry in the pool 110. The at least one sensor can be provided in the form of a pH probe, an oxidation-reduction potential (ORP) probe, a turbidity sensor, a total dissolved solids (TDS) probe, a free chlorine (FC) probe, a total available chlorine (TAC) probe, and combinations thereof. The at least one sensor may be designed to detect at least one of a turbidity level, a total dissolved solids level, a pH, an alkalinity, a cyanuric acid concentration, an oxidation-reduction potential, a heavy metal concentration, a microbial concentration, an algae concentration, an ozone concentration, a total chlorine level, a free chlorine level, or a combined chlorine level of the water.

The at least one sensor (not shown) may be located in the pool 110 and/or located in the pool pad 120, or otherwise in fluid communication with water disposed in the pool 110 or within one of the pool components or devices. For example, in one instance, the water quality monitor 127 includes at least one of the above-described sensors.

The system 100 may also include at least one chemical dispensing mechanism to maintain a desired water chemistry. In conventional systems, the at least one chemical dispensing mechanism may be included in the sanitizer 126, the pH regulator 128, and/or may be provided as a stand-alone system (not shown) included on or associated with the pool pad 120.

Still referring to FIG. 1, the system 100 can further include a central controller 150 and a portable user device 160 that can interface with the central controller 150, either directly over a local area network 170 or via a cloud network 170. Although FIG. 1 depicts one controller (i.e., the central controller 150), it should be noted that various wired and wireless communication methodologies and connections may be implemented to work in conjunction with, or independent from, at least one local controller associated with each component associated with the pool or spa system 100 (e.g., controller of the pump, controller of the heater, etc.).

Further, at least one of the components of the system 100 may be communicatively coupled to the central controller 150, the portable user device 160, and/or the network 170. Additionally, although FIG. 1 depicts one central controller 150 and one network 170, it should be noted that various communication processes and connections may be implemented to work in conjunction with, or independent from, at least one server and/or network associated with each of the components of the system 100 (i.e., pumps, valves, sensors, probes, etc., as discussed in above instances).

The network 170 can be provided in the form of a network interface, a local network, or other communication connection, and is not limited to the plurality of communication connections. One skilled in the art will recognize that a communication connection can transmit and receive data using a plurality of communication protocols, including but not limited to wired, wireless, Bluetooth, cellular, satellite, GPS, RS-485, RF, MODBUS, CAN, CANBUS, DeviceNet, ControlNet, Ethernet TCP/IP, RS-232, Universal Serial Bus (USB), Firewire, Thread, proprietary protocol(s), or other communication protocol(s) as applicable. In some instances, the network 170 is located proximate to one or more components of the system 100. The network 170 can include the Internet, intranets, extranets, wide area networks (“WANs”), local area networks (“LANs”), wired networks, wireless networks, cloud networks, or other suitable networks, or any combination of two or more networks, Ethernet networks, and other types of networks.

The central controller 150 and/or the portable user device 160 can be data-processing devices configured to transmit and receive data from the system 100. For example, the central controller 150 may receive information at a receiver included in the central controller 150. A processor included in the central controller 150 may analyze the received data and determine instructions to be sent back to the system 100. A transmitter of the central controller 150 may send the instructions from the processor to at least one component of the system 100.

The central controller 150 can further include a memory. The memory can be configured to store data received from the system 100. The memory can be implemented as a stand-alone memory unit and/or as part of a processor included in the central controller 150. Further, in one non-limiting instance, the network 170 may be coupled to the memory, which may include program instructions that are stored in the memory and executable by the processor to perform at least one of the methods described herein.

Additionally, in some instances, the portable user device 160 can be a user interface or display provided in the form of a local controller, a remote controller, and combinations thereof. Moreover, the portable user device 160 may be a handheld device (e.g., a mobile phone with or without an application, laptop, tablet, or other computing device).

Continuing with FIG. 1, the system 100 can include multiple devices associated with maintaining the water quality of the pool. Moreover, many of the devices can be designed to be communicatively coupled to the central controller 150, which can be designed to adjust at least one operating parameter and/or operating condition, schedule, maintenance routine, or other aspect of the devices. An owner may wish to operate the devices' performance in a way most beneficial to their specific system 100. Therefore, it may be beneficial to consider the volume of water contained within the pool 110 because the amount of water in the pool 110 can impact chemical dosing rates, heater scheduling or run time, filtration schedules, maintenance, and/or other operational parameters. However, the owner may not know the volume or have an accurate method to measure the volume. For example, the volume of the pool may not have been initially measured during construction, or further may not have been measured when the pool was filled for the first time. A system that can determine the volume of the pool facilitates the pool system set-up and enables the pool system to operate more efficiently and effectively with less maintenance and reduced costs. Thus, the following instances illustrate several systems and methods for (e.g., automatically) determining the volume of the pool 110 and/or adjusting at least one operating parameter of at least one pool device of the system 100 based on the determined pool volume.

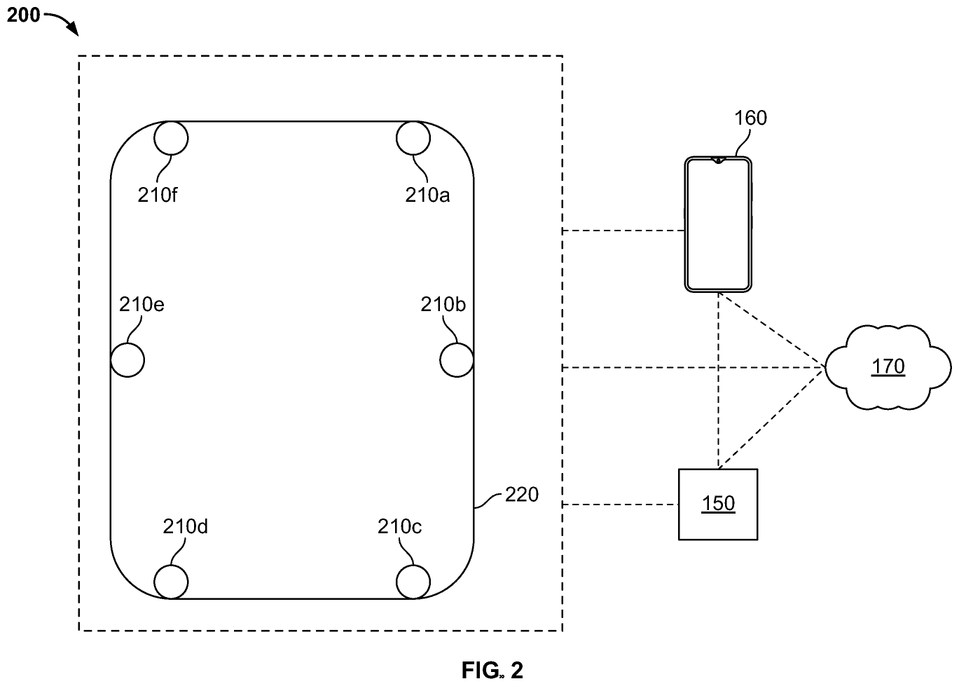

Now turning to FIGS. 2-5, various systems and methods for determining pool volume are discussed. Referring first to FIG. 2, a system 200 including at least one sensor in a pool is provided. The system 200 may be similar to the system 100. As such, the system 200 can include one or more of the components and/or pool devices of the system 100.

As illustrated, the system 200 includes six sensors 210a-210f positioned around the perimeter of a swimming pool 220 (or other aquatic application). The sensors 210a-210f may be collectively referred to as the sensors 210. As shown, the sensors 210 may be included in various locations circumscribing the interior of the pool 220 or around the perimeter of the pool 220. It is to be understood that the system 200 may include more or fewer sensors 210. Further, the sensors 210 may be positioned at any location in the pool 220, fluid circuit, and/or in the system 200, such as in a pool pad (not shown). Moreover, the sensors 210 can be integrated into or otherwise associated with one or more pool devices such as pool lights, a drain, a speaker, a skimmer, a floating device such as a pool toy or a floating chemical dispenser, a pool cleaner, a water feature, and/or components of a pool pad, such as a pump, a filter, a heating system, a sanitizer, a water quality monitor, or any other component or pool device disclosed herein, and/or accessories of the pool system 200, such as a robotic pool cleaner, an aerial device (e.g., drone), or an entertainment system (e.g., positioned near the perimeter of the pool).

In one instance, the sensors 210 are provided in the form of a temperature sensor. As shown, the sensors 210 can be communicatively coupled to the central controller 150 and/or the portable user device 160 over the network 170. Thus, temperature data from the sensors 210 can be stored in a memory included in the central controller 150. To determine the volume of the pool 220, the sensors 210 can measure the temperature of the pool water at a first time and then measure the temperature of the pool water at a second time (after the first time), after a pool heater, such as the heating system 125 of FIG. 1, has run for a known period of time. Because the approximate heat output of the heater and the approximate specific heat capacity of the pool water are known predefined values, the approximate volume of the pool 220 can be calculated by knowing the heater run time and the difference between the first and second temperature measurements. Thus, the approximate volume of the pool 220 is proportional to the rate of heating over the run time of the heater divided by the temperature change in the pool water. It should be appreciated that a single temperature sensor 210 can be used for the first and second temperature measurements, or a plurality of temperature sensors 210 may be used and the measurements may be averaged, normalized, or otherwise analyzed to determine the pool volume.

In one embodiment, the sensors 210 can be provided in the form of mapping sensors such as a camera, an ultrasonic transmitter and receiver, a visible green laser Light-Emitting Diode (LED), a photodiode, or other imaging sensors. The sensors 210 can be positioned at various locations in and around the pool 220 so that they can map the approximate pool surface area and/or pool depth. By measuring the amount of time it takes to send and receive a signal between the sensors 210, or between the sensors 210 and a surface or wall of the pool 220, the distance between the sensors 210 and/or the distance between the sensors 210 and the bounds of the pool 220 can be calculated. The controller 150 can interpret and aggregate this data to calculate the approximate volume of the pool 220. Further, the controller 150 can create a topographical map of the pool 220 using the data. For example, the sensors 210 may be embedded in components of the pool devices of the system 100, such as the pool lights (not illustrated) located in and around the pool 220. The sensors 210 can be configured to map the pool surface and facilitate determining the volume of the pool.

In another instance, the sensors 210 are provided in the form of a colorimeter. As discussed above, the pool pad 120 of FIG. 1 can include a water quality monitor 127. The water quality monitor 127 can be designed to monitor at least one water quality parameter such as chlorine, pH, alkalinity, calcium hardness, and any other known water quality parameters. Thus, the water quality monitor 127 may include a colorimeter. Thus, the sensors 210 can be integral with the water quality monitor 127 of FIG. 1 or can be provided as an additional sensor not included in the water quality monitor 127. To measure the approximate volume of the pool 220, the pool water can be dosed with a known amount of a chemical tracer agent. The chemical tracer agent can be provided in the form of a colored dye, an inert tracer agent, a fluorescent dye, cyanuric acid, or any other chemical tracer or treatment chemistry. At least one of the sensors 210 can measure the concentration of the tracer in the pool water at a first time. Thus, the first measurement can act as a baseline measurement. A chemical injection system such as the sanitizer 126 or the pH regulator 128 of FIG. 1, can then inject the tracer into the pool water. Finally, one or more of the sensors 210 can measure the concentration of the tracer at a second time after a sufficient period of time has passed for the pool water to circulate and evenly distribute the tracer throughout the pool 220. The central controller 150 can interpret the concentration data from the sensors 210 and determine the estimated pool volume by calculating the volume of water required to dilute the tracer from the first concentration to the second concentration. For example, a pool balancing chemical, such as cyanuric acid (CYA) can be used to determine pool volume by injecting a known amount of CYA concentration in parts per million (ppm) into the pool 220 using the sanitizer 126 or the pH regulator 128 of FIG. 1 at a first time, which may be before any other chemicals or reagents are added. The sensors 210 can then measure the ppm at a second time after the chemical reaction has taken place to determine the pool volume.

In other instances, the sensors 210 are provided in the form of flow sensors that may be embedded within one or more of the components of the system 100, such as in a hose (not illustrated) or a return line 140a-c of FIG. 1 that is used to fill the pool with its initial supply of water. The flow sensors 210 may determine the pool volume by measuring and/or quantifying the amount of water added to the pool 220 over a period of time.

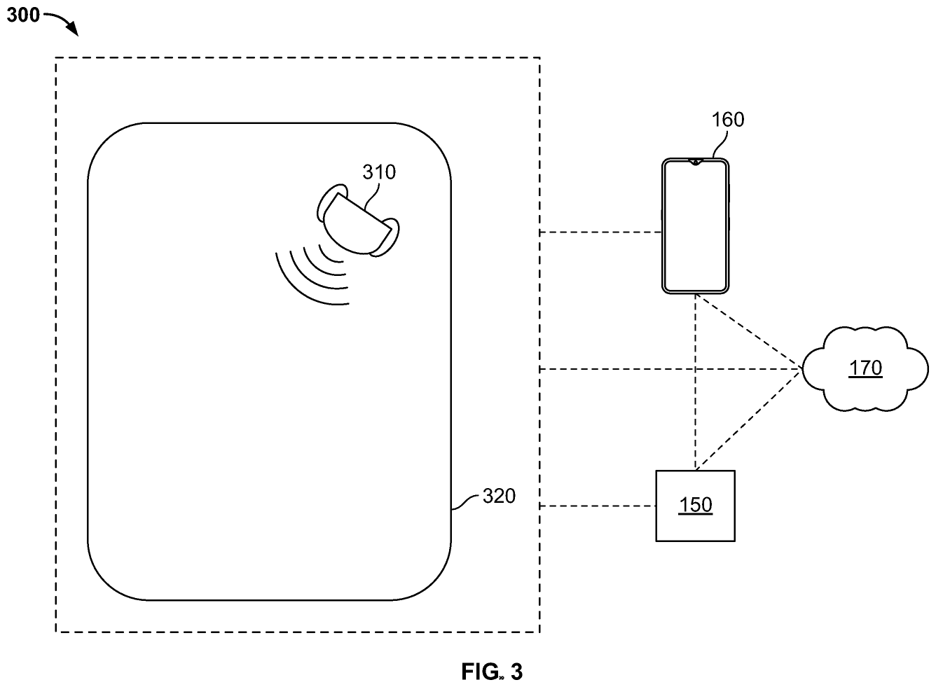

It is to be understood that although the sensors 210 are illustrated as stationary, at least one sensor can be included in moveable devices such as a floating chemical dispenser, a pool toy, a pool cleaner, or any other known movable pool device. For example, as shown in FIG. 3, a pool system 300 includes a pool cleaner 310 that can include at least one sensor used to determine the volume of a pool 320. The system 300 may be similar to the system 100. As such, the system 300 can include one or more of the components and/or pool devices of the system 100. As shown, the pool cleaner 310 can be provided in the form of a submersible robotic pool cleaner. The pool cleaner 310 can be the pool cleaner 116 of FIG. 1. In other instances, the pool cleaner 310 may be provided in the form of a suction side pool cleaner or a pressure side pool cleaner. Although examples are provided herein, is to be understood that the system 300 may include more or fewer sensors.

In one instance, the pool cleaner 310 includes at least one sonar or infrared sensor that is designed to topographically map the pool 320. The pool cleaner 310 can travel throughout the pool 320 and measure the pool wall height and size of the pool floor. The pool cleaner 310 can be communicatively coupled to the central controller 150. Thus, the central controller 150 can be designed to track the path of the pool cleaner 310 and may combine the movement data of the pool cleaner 310 with the measured pool wall height and pool floor area. For example, the central controller 150 may track the speed and movement (e.g., direction) of the pool cleaner 310. Using the data, the central controller 150 can create a map of the pool 320 and calculate the estimated volume of the pool 320.

In another instance, the pool cleaner 310 can include at least one sensor provided in the form of a pressure sensor. As the pool cleaner 310 travels throughout the pool 320, multiple pressure readings can be taken at various locations in the pool 320. The central controller 150 can receive and store the pressure readings and calculate an approximate depth of the pool 320 at each of the respective locations. Using several pressure readings and location data points, the central controller 150 can determine an approximate shape (i.e., area) of the pool 320. Thus, the central controller 150 can determine the approximate volume of the pool 320 by integrating at least one of the shape or area of the pool and/or the calculated depth over the area of the pool 320.

In some instances, the movable pool device including at least one sensor may be provided in the form of a floating scanner (not illustrated), such as a trichlor or dichlor floater. The floating scanner can use an ultrasonic transmitter and receiver or visible green laser LED and photodiode that calculates the distance to the walls of the pool 220 based on transit time in 360 degrees on water surface and straight down to the bottom of the pool 220. The floating scanner can aggregate this data to determine pool volume. The floating scanner may also be integrated into floating skimmer devices. Additionally, the floating scanner can be integrated into a pool toy, pool noodle, or any other pool floating device. The central controller 150 can receive and store aggregate data and calculate an approximate pool volume using the distance to the walls and/or the transit time.

The above instances are directed toward systems having sensors included within the interior of the pool (e.g., under the water, on the pool walls, located within a pool device in the boundary of the pool walls). However, it may be beneficial to have one or more sensors disposed exterior to the pool because it may be easier to perform maintenance on the sensors and the sensors may interfere less with a bather in the pool. As such, the below instances discuss methods and systems for determining pool volume with sensors positioned outside of the pool boundary defined by the walls of the pool.

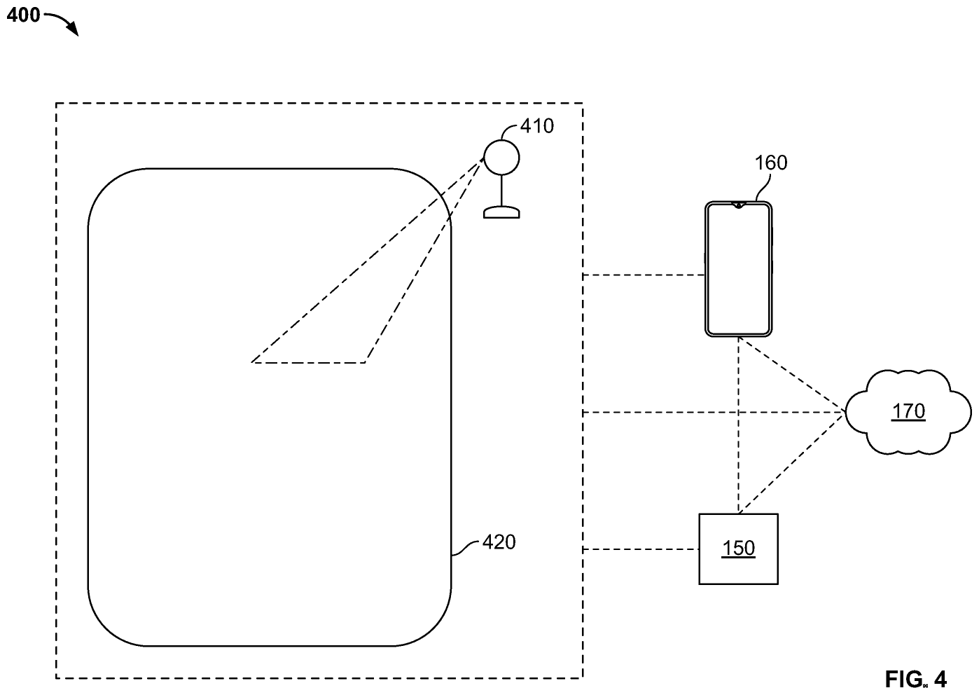

Turning to FIG. 4, a system 400 including a sensor 410 positioned near a pool 420 is illustrated. The system 400 may be similar to the system 100 and may include one or more of the components and/or pool devices of the system 100. The system 400 includes a single sensor 410 positioned near a corner of the pool 420, but outside of the boundary of the pool defined by the pool wall. However, it is to be understood that the system 400 may include more or fewer sensors. Further, the sensor 410 may be positioned at any location around or near the pool, such as in a pool pad (not shown), on pool furniture, on a fence, on a railing, on a house, on a pool deck, on a tree, in an entertainment system near the pool, and the like. Although the sensor 410 is shown as being elevated, it is to be understood that the sensor may be positioned at ground level. Moreover, the sensor 410 may be communicatively coupled to the central controller 150 and the portable user device 160.

In one instance, the sensor 410 is provided in the form of a thermal imaging camera. Ideally, the sensor 410 is positioned so that the sensor can measure the entirety of the pool 420. Thus, as shown, the sensor 410 may be elevated. The sensor 410 is designed to capture a thermal image of the system 400. Generally, the pool water will have a lower temperature than the surrounding ambient environment. As such, the central controller 150 receives the image from the sensor 410 and determines the approximate shape of the pool 420 by detecting a difference in temperature in the received image. Moreover, the central controller 150 may be able to determine the approximate depth of the pool 420 by tracking a bather. Generally, a bather will have a higher temperature than the pool water and the surrounding environment. Thus, the central controller 150 can analyze the data from the thermal image captured by the sensor 410 to determine if a bather is present. Similar to determining the size of the pool 420 based on the heat signature of the pool, the central controller 150 can determine the approximate height of the bather on land by their heat signature. Once the bather enters the pool 420, the sensor 410 can continue to monitor the system 400, thereby tracking the location of the bather. Using the calculated height of the bather, the controller can determine the approximate depth of the pool 420 by determining how much of the bather is above the water (i.e., the height of the bather under the pool water may be approximately equal to the pool depth at the measured location).

In another instance, the sensor 410 is provided in the form of a handheld device or a wearable device. A benefit of a handheld or wearable device is that the user can move around the system 400 to take measurements at various locations. Thus, the data may be more accurate as compared to a single sensor or a stationary sensor. For example, the handheld or wearable device may be used by a pool installer to get an initial mapping of the pool 420. In other examples, a bather may use the handheld or wearable device to map the pool 420.

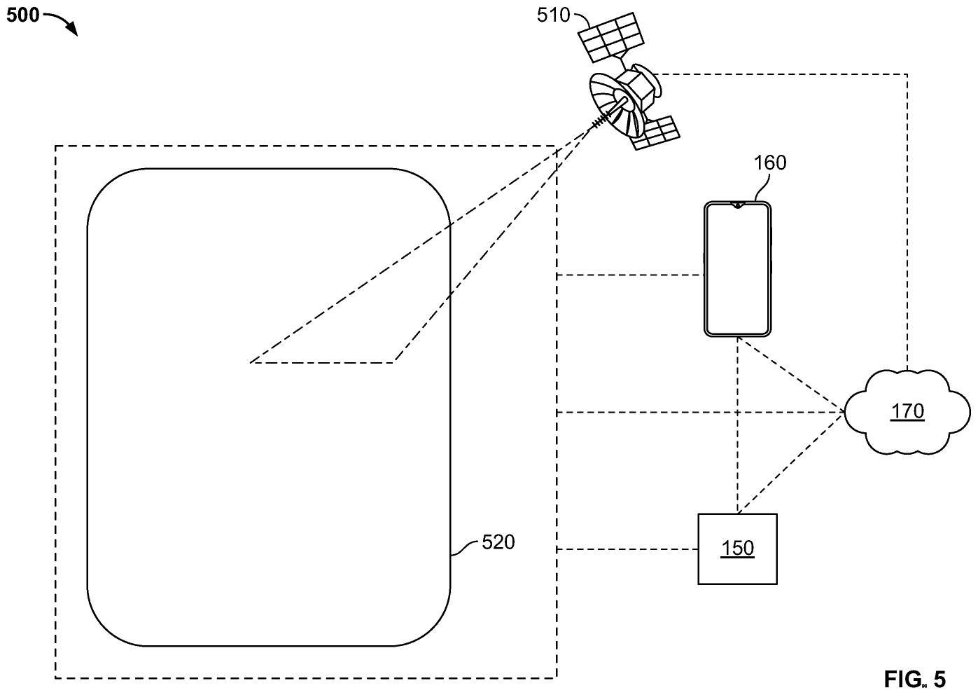

Turning to FIG. 5, a system 500 designed to determine the volume of a pool with an aerial device 510 is illustrated. The system 500 may be similar to the system 100 and may include one or more of the components and/or pool devices of the system 100.

The aerial device 510 may be provided in the form of a satellite (e.g., drone) communicatively coupled to the network 170. The aerial device 510 can include at least one imaging and/or positioning sensor, such as a global positioning system (GPS).

In one instance, the aerial device 510 is designed to take one or more aerial images of a pool 520. The central controller 150 can receive the image data and determine the approximate surface area of the pool 520. The central controller 150 can further combine the aerial data with other data such as stored data about the depth of the pool 520. The surface area data and/or the depth data can be stored in a memory of the central controller 150.

The depth data can be provided in the form of user input data, public record data such as building code or plat data associated with the pool 520, industry data for similar models of pools, data collected by sensors disclosed herein, or other known types of pool system data for tracking depth. Using the aerial data and the depth data, the central controller 150 can calculate the approximate volume of the pool 520.

In one instance, the aerial device 510 can track a bather wearing a wearable device (e.g., GPS device, such as a smartwatch). The aerial device 510 may be able to determine an approximate altitude (i.e., depth) of the bather as they swim in the pool 520. Thus, the central controller 150 can use both the location and altitude data to determine an approximate volume of the pool 520.

Referring back to FIG. 1, and as discussed in the above instances, the central controller 150 can operate and/or communicate with at least one component and/or pool device, including the sensors disclosed herein. Thus, the central controller 150 can also be configured to track and store the collected data and upload the data to a third-party network. The third-party network may be the network 170 or may be provided as a separate network (not shown) in communication with the network 170. The third-party network may track and store the data and aggregate data from at least one pool system. As such, the third-party network may contain statistics on similar size pools.

Thus, determining the pool volume as disclosed herein and/or using the statistical data from the third-party network along with the measured parameters as discussed herein, the central controller 150 can adjust at least one operating parameter of the various pool components such as filter run time, pump speed, chemical dosage rate, heater run time, maintenance schedules, and the like.

For example, in one instance, by knowing the volume of the pool using one of the systems or methods described herein, the central controller 150 can determine how long it will take to cycle the water of the system. Thus, the central controller 150 can automatically start a pump, such as the variable speed pump 122 and/or the booster pump 123, so that the water of the pool has cycled through the system at least once prior to a bather entering the pool. This may help ensure the pool water is filtered prior to the bather entering the water.

In one instance, the central controller 150 can determine the optimal chemical treatment dosage based on the pool volume. Thus, the central controller 150 can help ensure that a sufficient amount of treatment chemistry (such as a treatment chemical) is injected into the pool water without injecting excess chemicals that can irritate the skin of a bather or unnecessarily waste the chemicals.

In one instance, the central controller 150 can determine how long it will take to heat the volume of water in the pool. Thus, the central controller 150 can automatically turn on a heating system, such as the heating system 125 of the pool system 100 so the pool water is at a desired temperature for a bather prior to the time the bather wants to swim.

In general, the pool volume may be determined by the systems and methods disclosed herein at various time periods. In particular, the initial pool volume may be determined during a configuration operation as the pool is being installed or set up. Further, the pool volume may be determined or recalibrated after a storm has added water to the pool, after an extreme heat event where water has evaporated, or at other intervals. For example, the pool volume may be remeasured on a daily, weekly, monthly, or annual basis. As such, one or more pool devices may be recalibrated and/or the controller 150 can adjust at least one operating parameter of one or more pool components after the pool volume is determined.

It will be appreciated by those skilled in the art that while the invention has been described above in connection with particular instances and examples, the invention is not necessarily so limited and that numerous other instances, examples, uses, modifications and departures from the instances, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method for calibrating a pool device for a pool, comprising:
providing a sensor;
collecting pool data with the sensor;
determining a volume of the pool based on the collected pool data;
inputting the determined volume of the pool into a user interface; and
adjusting at least one operating parameter of the pool device based on the determined volume of the pool.

2. The method of claim 1, wherein the user interface is in communication with a controller including a memory to store the determined volume of the pool.

3. The method of claim 1, wherein the sensor is provided in the form of a pressure sensor of a submersible vehicle, and the sensor is designed to track a location of the submersible vehicle and determine a shape of the pool based on the tracked location.

4. The method of claim 3, wherein calculating the volume of the pool includes:
measuring a first water pressure of pool water at a first location via the submersible vehicle;
measuring a second water pressure of the pool water at a second location via the submersible vehicle;
determining a first depth of the pool at the first location based on the first water pressure and determining a second depth of the pool at the second location based on the second water pressure; and
calculating the volume of the pool based on the shape and the first depth of the pool and the second depth of the pool.

5. The method of claim 1, wherein the sensor is provided in the form of a sonar sensor or an infrared sensor integrated into a robotic pool cleaner.

6. The method of claim 5, wherein determining the volume of the pool includes mapping a surface of the pool with the robotic pool cleaner.

7. The method of claim 1, wherein the sensor is associated with a light located in the pool.

8. The method of claim 1, wherein the sensor is a flow sensor associated with a pool conduit and designed to determine the volume of the pool by quantifying an amount of water added to the pool.

9. The method of claim 1, wherein the sensor is provided in the form of a thermal imaging camera, and wherein determining the volume of the pool includes capturing a thermal image of the pool via the thermal imaging camera.

10. The method of claim 1, wherein the sensor is provided in the form of a handheld device, and the volume of the pool is calculated by moving the handheld device around the interior of the pool to obtain a mapping of the pool.

11. The method of claim 2, wherein the sensor is provided in the form of an imaging sensor or a positioning sensor provided in an aerial device.

12. The method of claim 11, wherein the aerial device includes a global positioning system (GPS), and calculating the volume of the pool includes:
taking at least one aerial image of the pool,
sending the at least one aerial image to the controller, and
combining data received from the at least one aerial image and data stored in the controller to determine the volume of the pool.

13. A method for calibrating a pool device for a pool, comprising:
measuring a first water temperature of pool water via a sensor at a first calibration time;
operating a heater to heat the pool water;
measuring a second water temperature of the pool water via the sensor at a second calibration time;
determining a run time of the heater with a controller based on a difference between the second calibration time and the first calibration time;
determining a change in the water temperature with the controller based on a difference in temperature of the pool water between the second calibration time and the first calibration time;
determining a volume of the pool based on at least one of the run time of the heater, the change in the water temperature, or a heating rate of the heater;
storing the volume of the pool into a user interface for the pool device; and
adjusting at least one operating parameter of the pool device based on the volume of the pool.

14. The method of claim 13, wherein the sensor sends the first water temperature and the second water temperature measurements to the controller.

15. The method of claim 14, wherein the sensor is communicatively coupled to the user interface via a network.

16. A method for calibrating a pool device for a pool, comprising:
injecting a chemical tracer reagent into water of the pool;
circulating the water of the pool for a pre-determined period of time;
measuring a concentration of the chemical tracer reagent;
calculating a volume of the pool based on the measured concentration of the chemical tracer reagent;
inputting the volume of the pool into a user interface for the pool device; and
automatically adjusting at least one operating parameter of the pool device based on the volume of the pool.

17. The method of claim 16, wherein the concentration of the chemical tracer reagent is measured with a colorimeter.

18. The method of claim 17, wherein the chemical tracer reagent is provided in the form of cyanuric acid.

19. The method of claim 16, further including measuring a baseline concentration of the chemical tracer reagent prior injecting the chemical tracer reagent into the water of the pool.

20. The method of claim 16, wherein the adjusted operating parameter is at least one of a filter run time, a pump speed, a chemical dosage rate, a heater run time, or a maintenance schedule.
